(19) United States
(12) Patent Application Publication
(10) Pub. No.: US 2013/0327011 A1
(43) Pub. Date: Dec. 12, 2013

(54) Method And Apparatus For A Fuel Nozzle Assembly For Use With A Combustor

(71) Applicants: Brandon Taylor Overby, Spartanburg, SC (US); Dereck Joseph Ouellet, Pelzer, SC (US)

(72) Inventors: Brandon Taylor Overby, Spartanburg, SC (US); Dereck Joseph Ouellet, Pelzer, SC (US)

(21) Appl. No.: 13/492,561

(22) Filed: Jun. 8, 2012

(51) Int. Cl. F02C 7/20; B23P 19/00

(52) U.S. Cl. 60/39.091; 29/889.22; 60/796

(57) ABSTRACT

A fuel nozzle assembly for use with a combustor is provided. The fuel nozzle assembly includes a fuel nozzle including a discharge end. A cap is coupled adjacent to the nozzle discharge end, wherein the cap includes an outer surface. At least one dampener mechanism is coupled to the cap outer surface to facilitate reducing vibrations induced to the fuel nozzle.

### BACKGROUND OF THE INVENTION

The field of the present disclosure relates generally to turbine engines and, more specifically, to a fuel nozzle assembly for use with a combustor.

At least some known turbine engines use fuel injection assemblies to supply a mixture of fuel and gas to a combustor. The mixture is supplied to the combustor of a gas turbine engine wherein it is ignited within the combustion zone and the energy therefrom is directed to a downstream turbine assembly. At least some known fuel injection assemblies include relatively long feed tubes and fuel nozzles that couple to feed sources external to the combustor and extend a distance into the combustor. As the feed flows are channeled through the fuel nozzles at relatively high velocities, vibrations may be induced to the fuel nozzles. Over time, such vibrations may cause premature failure of components of the feed injector.

To reduce harmful vibrations induced to fuel nozzle components, some known combustion systems use a plurality of hula seals. More specifically, in at least some known combustors, hula seals encapsulate the combustor liner, including the fuel nozzles, and function as a spring bias between the combustor liner and the surrounding transition section. As such, known hula seals do not reduce vibrations. Rather, hula seals merely attempt to reduce transmitting vibrations between the combustor liner and the transition section.

### BRIEF DESCRIPTION OF THE INVENTION

In one embodiment, a method of assembling a combustor assembly is provided. The method includes coupling a cap adjacent to a discharge end of a fuel injection nozzle and coupling at least one dampener mechanism to the cap. The method also includes positioning the fuel injection nozzle within the combustor assembly such that the dampener mechanism facilitates reducing vibrations induced to the fuel injection nozzle during combustor operation.

In another embodiment, a fuel nozzle assembly for use with a combustor is provided. The fuel nozzle assembly includes a fuel nozzle having an inlet end and an opposite discharge end. A cap is coupled adjacent to the nozzle discharge end, wherein the cap includes an outer surface and at least one dampener. The dampener is coupled to the cap outer surface to facilitate reducing vibrations induced to the fuel nozzle.

In yet another embodiment, a gas turbine assembly is provided. The gas turbine assembly includes a combustor and a fuel nozzle extending into the combustor. The fuel nozzle includes an inlet end and an opposite discharge end. The assembly also includes at least one dampener mechanism coupled to the fuel nozzle adjacent to the discharge end. The dampener mechanism is configured such that it facilitates reducing vibrations induced to the fuel nozzle.

### BRIEF DESCRIPTION OF THE DRAWINGS

FIG. 1 is a schematic view of an exemplary turbine engine.

FIG. 2 is a sectional view of an exemplary fuel nozzle assembly that may be used with the turbine engine shown in FIG. 1 taken along Area 2.

FIG. 3 is a view of an exemplary cap assembly shown in FIG. 2 and taken along line 3-3.

FIG. 4 is a sectional view of the fuel nozzle assembly shown in FIG. 2 taken along Area 4.

FIG. 5 is a partially transparent view of an exemplary assembled dampener mechanism that may be used with the fuel nozzle assembly shown in FIG. 2.

FIG. 6 is a sectional view of a portion of the dampener mechanism shown in FIG. 5.

FIG. 7 is a cross-sectional view of a portion of the dampener mechanism shown in FIG. 5.

FIG. 8 is a sectional view of an alternative exemplary dampener mechanism that may be used with the fuel nozzle assembly shown in FIG. 2.

FIG. 9 is a cross-sectional view of the dampener mechanism shown in FIG. 8.

### DETAILED DESCRIPTION OF THE INVENTION

Nitrogen oxide (NOx) emissions may be produced from the reaction of nitrogen and oxygen gases during combustion at high temperatures. Such emissions are generally undesirable and may be harmful to the environment. To facilitate reducing NOx emissions in a gas turbine plant, selective catalytic reduction (SCR) systems have been implemented. Known SCR systems convert NOx, with the aid of a catalyst, into elemental nitrogen and water. However, SCR systems generally increase the overall costs associated with turbine operation.

To offset the higher costs associated with SCR operations, at least some known power generation systems use longer fuel nozzles to supply fuel to the combustor of a gas turbine. The additional length associated with such fuel nozzles increases the mixing zone of ignition gases, which in turn helps to reduce NOx emissions. However, as the length of a fuel nozzle increases, its fundamental vibration characteristics will change resulting in undesirable dynamic response to combustion tones, fluid flow, and/or rotor harmonics. Therefore, a fuel nozzle assembly that reduces fuel nozzle vibration response to various excitation sources within the turbine may be desirable.

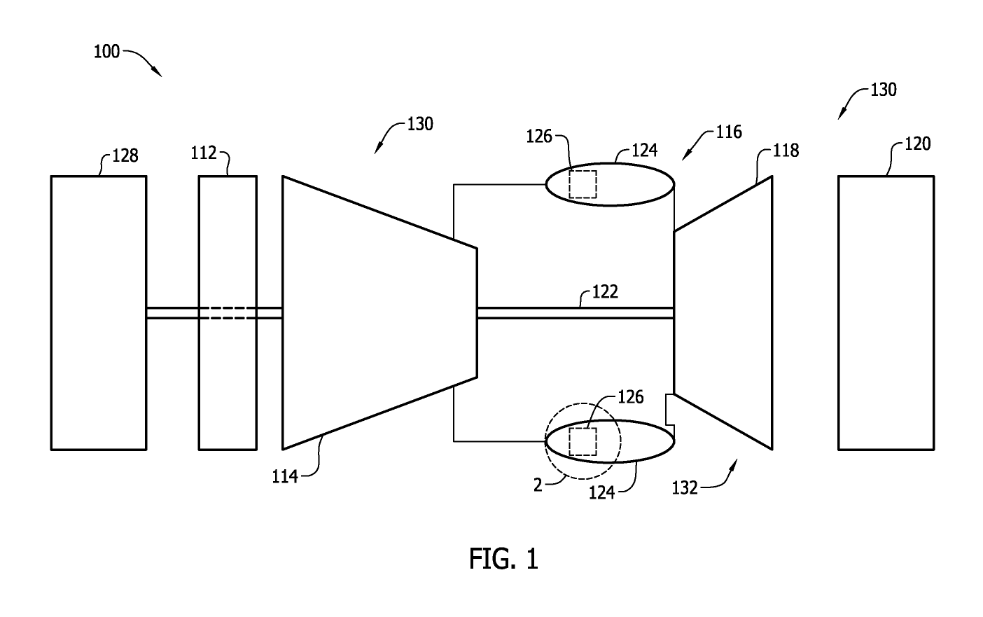

FIG. 1 is a schematic view of an exemplary turbine engine 100. More specifically, in the exemplary embodiment turbine engine 100 is a gas turbine engine. While the exemplary embodiment illustrates a gas turbine engine, the present invention is not limited to any one particular engine, and one of ordinary skill in the art will appreciate that the current invention may be used in connection with other turbine engines.

In the exemplary embodiment, turbine engine 100 includes an intake section 112, a compressor section 114 downstream from intake section 112, a combustor section 116 downstream from compressor section 114, a turbine section 118 downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is in flow communication with compressor section 114. A fuel nozzle assembly 126 is coupled within each combustor 124. Turbine section 118 is coupled to compressor section 114 and to a load 120 such as, but not limited to, an electrical generator and/or a mechanical drive application through rotor shaft 122. In the exemplary embodiment, each of compressor section 114 and turbine section 118 includes at least one rotor disk assembly 130 that is coupled to rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and other fluids provided by each fuel nozzle assembly 126 and then ignited to generate combustion gases that are channeled towards turbine section 118. More specifically, each fuel nozzle assembly 126 injects fuel, such as natural gas and/or fuel oil, air, diluents, and/or inert gases, such as nitrogen gas (N₂), into respective combustors 124, and into the air flow. The fuel mixture is ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132. Because fuel nozzle assembly 126 injects the fuel with air, diluents, and/or inert gases, NOx emissions may be reduced within each combustor 124.

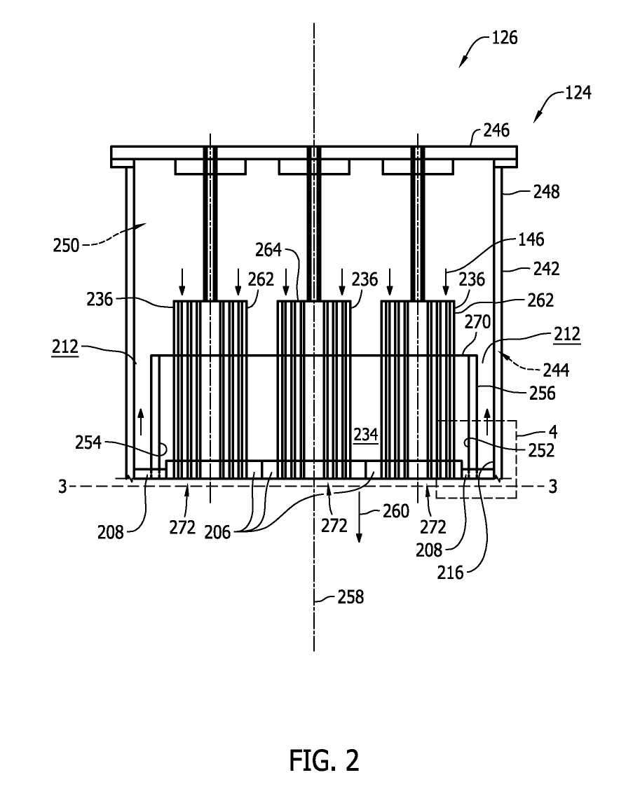

FIG. 2 is a sectional view of an exemplary of fuel nozzle assembly 126 taken along area 2 (shown in FIG. 1). In the exemplary embodiment, combustor assembly 124 includes a casing 242 that defines a chamber 244 within casing 242. An end cover 246 is coupled to an outer portion 248 of casing 242 such that an air plenum 250 is defined within chamber 244. Compressor section 114 (shown in FIG. 1) is coupled in flow communication with chamber 244 to enable compressed air to be channeled downstream from compressor section 114 to air plenum 250.

In the exemplary embodiment, each combustor assembly 124 includes a combustor liner 252 within chamber 244 and that is coupled in flow communication with turbine section 118 (shown in FIG. 1) via a transition piece (not shown) and with compressor section 114. Combustor liner 252 includes a substantially cylindrically-shaped inner surface 254 that extends between an aft portion (not shown) and a forward portion 256. Inner surface 254 defines annular combustion chamber 234 that extends axially along a centerline axis 258, and extends between the aft portion and forward portion 256. Combustor liner 252 is coupled to fuel nozzle assembly 126 such that assembly 126 channels fuel and air into combustion chamber 234. Combustion chamber 234 defines a combustion gas flow path 260 that extends from fuel nozzle assembly 126 to turbine section 118. In the exemplary embodiment, fuel nozzle assembly 126 receives a flow of air from air plenum 250 and receives a flow of fuel from fuel supply system 138. A mixture of fuel/air is then channeled from plenum 250 into combustion chamber 234 for generating combustion gases.

In the exemplary embodiment, an end plate 270 is coupled to liner forward portion 256 such that end plate 270 at least partially defines combustion chamber 234. End plate 270 includes a plurality of openings 272 that extend through end plate 270, and that are each sized and shaped to receive a fuel nozzle 236 therethrough. Each nozzle 236 is at least partially inserted within a corresponding opening 272 such that fuel nozzle 236 is coupled in flow communication with combustion chamber 234. Alternatively, fuel nozzles 236 may be coupled to combustor liner 252 without the inclusion of end plate 270.

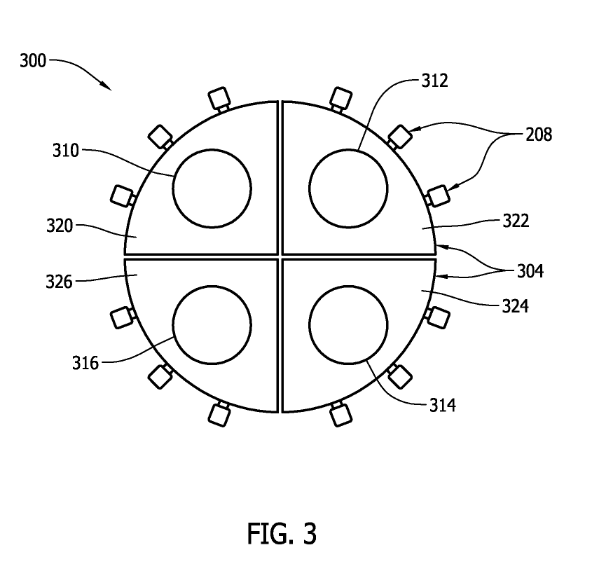

In the exemplary embodiment, fuel nozzle assembly 126 includes a plurality of fuel nozzles 236 that are each at least partially positioned within air plenum 250. More specifically, fuel nozzle assembly 126 includes a plurality of fuel nozzles 236 that are considered to be “long” fuel nozzles. For example, fuel nozzles 236 include a first fuel nozzle 310, a second fuel nozzle 312, a third fuel nozzle 314, and a fourth fuel nozzle 316 (each shown in FIG. 3). Fuel nozzles 236 are spaced circumferentially relative to centerline 258. In one exemplary embodiment, a fuel nozzle 236 may lie on centerline 258 while a plurality of other fuel nozzles 236 are spaced circumferentially about centerline 258. Fuel nozzles 236 extend into combustion chamber 234 such that nozzles 236 are substantially parallel with respect to centerline 258. As used herein, the term “long fuel nozzle” means a fuel nozzle having a length of approximately 27 inches.

FIG. 3 is a view of a cap assembly 300 taken along line 3-3. In the exemplary embodiment, cap assembly includes first fuel nozzle 310, second fuel nozzle 312, third fuel nozzle 314, and fourth fuel nozzle 316. Furthermore, a cap 206 is coupled to each fuel nozzle 310, 312, 314, and 316. For example, a first cap 320 is coupled to first fuel nozzle 310, a second cap 322 is coupled to second fuel nozzle 312, a third cap 324 is coupled to third fuel nozzle 314, and a fourth cap 324 is coupled to fourth fuel nozzle 316. Although the exemplary embodiment includes four fuel nozzles and four caps, it should be understood that cap assembly 300 may include any suitable number of fuel nozzles and caps. In an alternative embodiment, a plurality of caps 206 may be coupled along a length (not shown) of fuel nozzle 236. Furthermore, in the exemplary embodiment, each cap 320, 322, 324, and 326 includes an arcuately oriented outer surface 304, and caps 320, 322, 324, and 326 are arranged to form a substantially circular cap assembly 300. As such, when cap assembly 300 is inserted into combustion chamber 234, cap assembly 300 is substantially concentric with substantially cylindrically-shaped inner surface 254.

Furthermore, in the exemplary embodiment, caps 320, 322, 324, and 326 include one or more dampener mechanisms 208. For example, in the exemplary embodiment, three dampener mechanisms 208 are coupled to outer surface 304 of each cap 320, 322, 324, and 326. As such, dampener mechanisms 208 are spaced circumferentially about each fuel nozzle 236 and cap assembly 300. Furthermore, it should be understood that any suitable number of dampener mechanisms 208 may be used to facilitate reducing vibrations induced to fuel nozzles 310, 312, 314, and 316. Furthermore, in the exemplary embodiment, dampener mechanisms 208 extend from outer surface 304 to contact a combustor casing wall 216. Furthermore, in one exemplary embodiment, dampener mechanism 208 extends through an opening (not shown in FIG. 3) defined in combustor liner 252 to contact casing wall 216. As such, dampener mechanisms 208 are configured to contact casing wall 216 simultaneously.

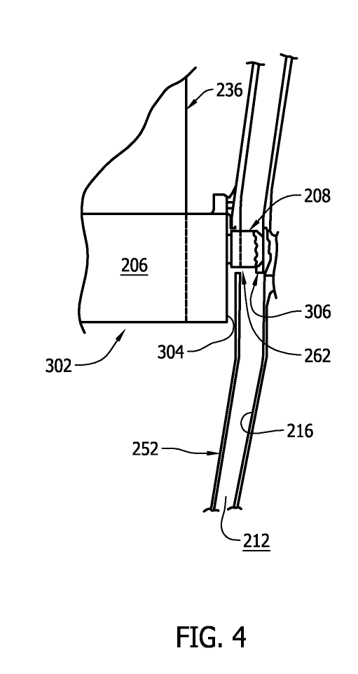

FIG. 4 is a sectional view of fuel nozzle assembly 126 taken along Area 4. In the exemplary embodiment, dampener mechanism 208 extends through opening 262 defined in combustor liner 252 and contacts casing wall 216. Furthermore, in the exemplary embodiment, dampener mechanism 208 includes a biasing mechanism (not shown in FIG. 4) such that dampener mechanism 208 is partially compressed when pressed against casing wall 216. During operation, fuel nozzle 236 vibrates and dampener mechanism 208 contacts casing wall 216 to substantially stabilize fuel nozzle 236 via end cap 206. In the exemplary embodiment, the vibrations from fuel nozzle 236 cause dampener mechanism 208 to repeatedly contact casing wall 216, which may damage dampener mechanism 208. As such, in the exemplary embodiment, dampener mechanism 208 includes a wear coating 306 applied over a portion of dampener mechanism 208.

Furthermore, in the exemplary embodiment, at least a portion of dampener mechanism 208 is positioned within airflow path 212. Air flows within airflow path 212 to be used for premixing purposes within fuel nozzle 236. As such, in the exemplary embodiment, dampener mechanism 208 is configured to facilitate wake mitigation of airflow within path 212 to prevent flame holding problems in recirculation zones. For example, in the exemplary embodiments, dampener mechanism 208 may have an aerodynamic cross-sectional shape such as an elliptical shape, a cylindrical shape, a tear drop shape, or an airfoil shape. Furthermore, in the exemplary embodiments, dampener mechanism includes an outer surface 304 contoured to facilitate flush contact with casing wall 216. For example, in the exemplary embodiments, outer surface 304 includes an arcuately contoured contact surface.

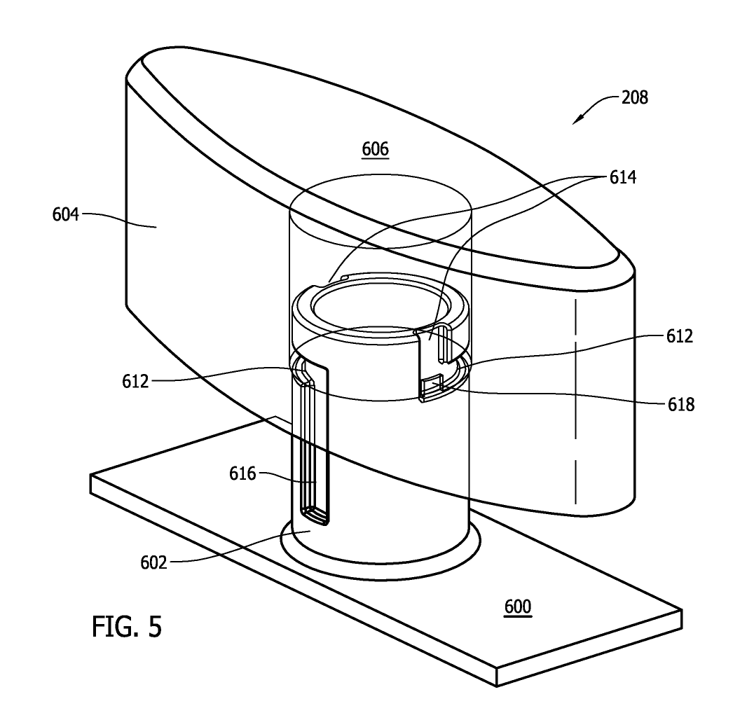

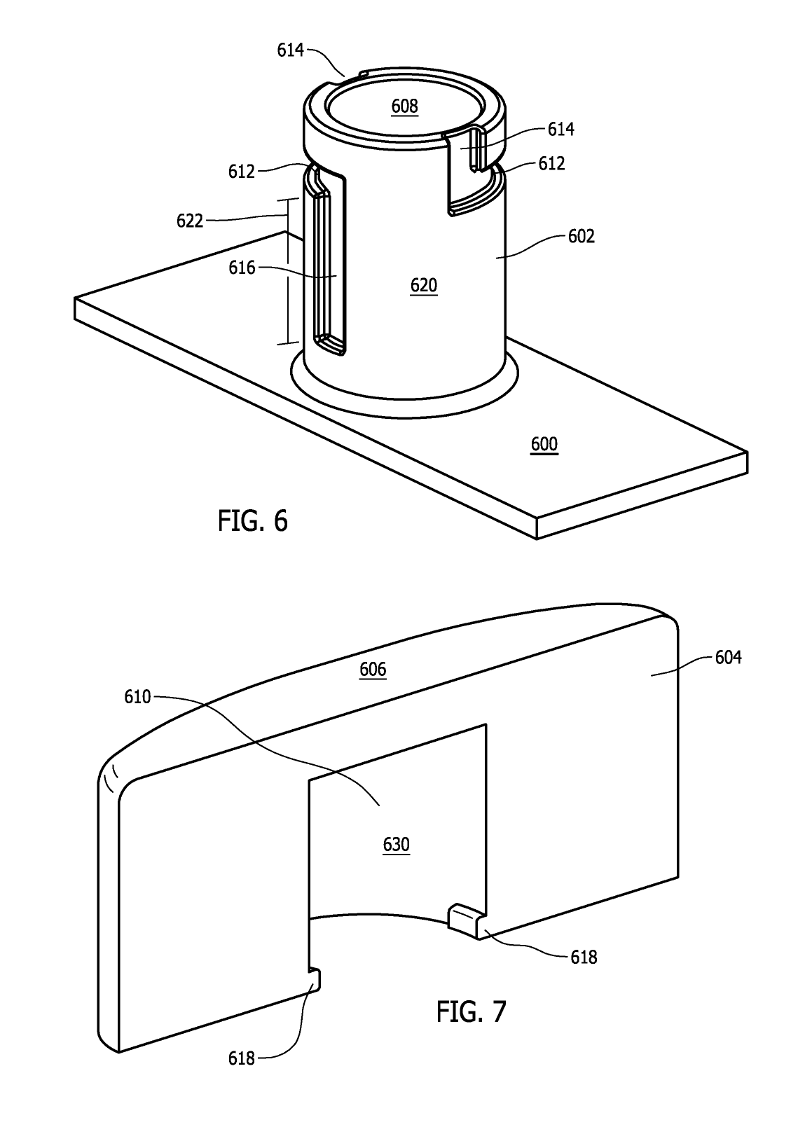

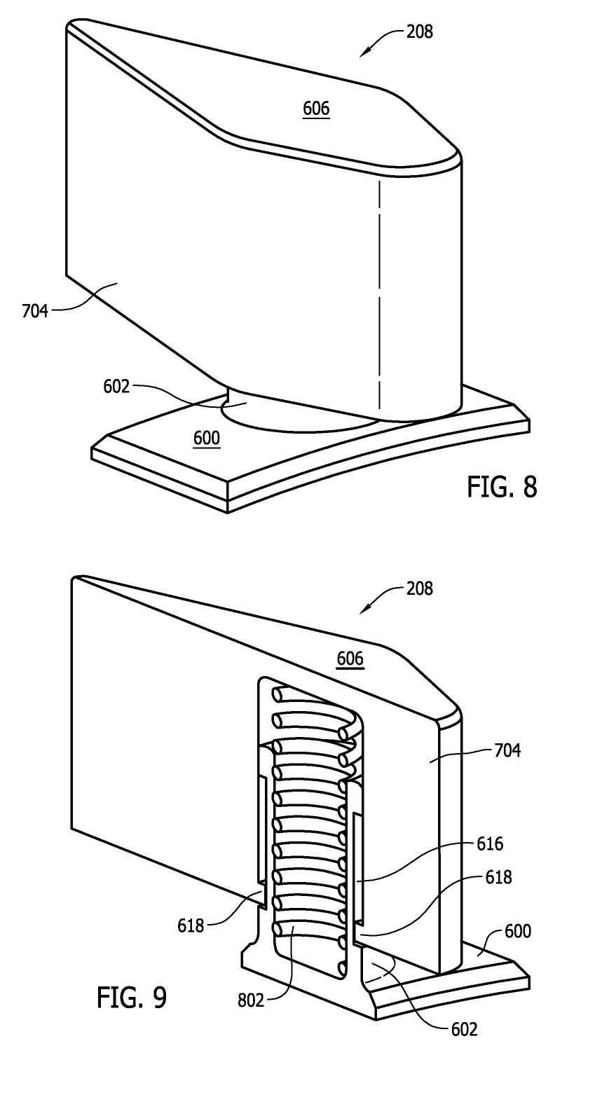

FIGS. 5-9 are perspective and cross-sectional views of dampener mechanism 208. In the exemplary embodiment, dampener mechanism 208 includes a base 600, a housing 602, and one of an end cap 604 and 704. Although end cap 604 will be discussed in more detail, it should be understood that the same applies to end cap 704. Housing 602 extends from base 600 and has a substantially cylindrical shape. Furthermore, in the exemplary embodiment, housing 602 includes, in serial relationship, first axial indents 614, radial indents 612, and second axial indents 616 that are each disposed within an outer surface 620 of housing 602. Furthermore, in the exemplary embodiment, end cap 604 includes an end cap orifice 610 sized to receive housing 602 and connectors 618 coupled to an interior surface 630 of end cap orifice 610. As such, end cap 604 is coupled to housing 602 by engaging connectors 618 with indents, 612, 614, and 616. For example, in the exemplary embodiment, connectors 618 insert into first axial indents 614, slide circumferentially within radial indents 612, and slidably interlock with axial indents 616. As such, when dampener mechanism 208 is pressed against casing wall 216, connectors 618 facilitate biasing end cap 604 with respect to housing 602.

Furthermore, in the exemplary embodiment, housing 602 includes a housing orifice 608 and end cap 604 includes end cap orifice 610. End cap orifice 610 is sized to receive housing 602 therein. Furthermore, in the exemplary embodiment, end cap orifice 610 and housing orifice 608 are each sized to receive at least a portion of a biasing mechanism such as a spring 802. Spring 802 is positioned within housing orifice 608 and end cap orifice 610 to facilitate biasing end cap 604 when dampener 208 is pressed against combustor liner 252 or flow sleeve 212. As such, spring 802 facilitates biasing end cap 604 a distance equivalent to a length 622 of axial indents 616. Furthermore, although dampener 208 includes spring 802 in the exemplary embodiments, dampener 208 may include any suitable biasing mechanism to facilitate reducing vibrations induced to fuel nozzles 236. For example, in an alternative embodiment, a biasing mechanism may include a coil-over system including a coil spring encircling a shock absorber. As such, in the alternative embodiment, the shock absorber reduces vibrational amplitudes and the spring provides stiffness and support to the shock absorber.

Furthermore, in the exemplary embodiments, end caps 604 and 704 are each configured to have a cross-sectional shape that facilitates wake mitigation in airflow path 212 (shown in FIG. 4). For example, in the exemplary embodiments, end cap 604 has a substantially elliptical cross-sectional shape and end cap 704 has an airfoil cross-sectional shape. However, it should be understood that end caps 604 and 704 may have any suitable shape to facilitate wake mitigation. For example, in alternative embodiments end caps may have an aerodynamic cross-sectional shape such as an elliptical shape, a cylindrical shape, a tear drop shape, or an airfoil shape. Furthermore, in the exemplary embodiments, end caps 604 and 704 each include a first surface 606 contoured to facilitate flush contact with casing wall 216. For example, in the exemplary embodiments, first surface 606 includes an arcuately contoured contact surface. As such, first surface 606 substantially mates with either combustor liner 252 or flow sleeve 212. Furthermore, in the exemplary embodiments, wear coating 306 (shown in FIG. 4) is applied over first surface 606 to facilitate reducing damage to end caps 604 and 704.

A method of assembling a combustor assembly is provided herein. The method includes coupling cap 604 adjacent to a discharge end 302 (shown in FIG. 4) of fuel nozzle 236, coupling at least one dampener mechanism 208 to cap 206, and positioning fuel injection nozzle 236 within combustor assembly 124. Furthermore, the biasing mechanism positioned within dampener mechanism 208 may cause dampener mechanism 208 to expand such that fuel nozzle 236 is unable to be positioned within combustor assembly 124. As such, dampener mechanism 208 is at least partially compressed prior to positioning fuel injection nozzle 236 within combustor assembly 236. Dampener mechanism 208 is then released when fuel nozzle 236 reaches a desired position within combustor assembly 124. Once released, dampener mechanism 208 contacts casing wall 216.

The fuel nozzle assembly described herein facilitates reducing vibrations induced to fuel nozzles. More specifically, the dampener mechanism described herein is coupled to a fuel nozzle cap and extends from the cap to contact the combustor casing wall. As such, the dampener mechanism acts as a buffer between the fuel nozzle and the combustor casing wall. Long fuel nozzles are increasingly being used to facilitate premixing air and fuel to reduce NOx emissions. However, as the length of a fuel nozzle is increased, its fundamental vibration characteristics will change, possibly resulting in undesirable dynamic response to combustion tones, fluid flow, and/or rotor harmonics. Such dynamic response may cause the fuel nozzle to repeatedly contact combustor components, which may damage the combustor components and fuel nozzles. As such, the dampener mechanism described herein absorbs fuel nozzle vibrations or alters dynamic response characteristics to facilitate reducing damage to turbine engine components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of assembling a combustor assembly, said method comprising:
coupling a cap adjacent to a discharge end of a fuel nozzle;
coupling at least one dampener mechanism to the cap; and
positioning the fuel nozzle within the combustor assembly such that the at least one dampener mechanism facilitates reducing vibrations induced to the fuel nozzle during combustor operation.

2. The method in accordance with claim 1, wherein positioning the fuel nozzle within the combustor assembly comprises positioning the dampener mechanism to extend between the cap and a combustor casing wall.

3. The method in accordance with claim 1, wherein coupling at least one dampener mechanism to the cap comprises coupling at least one dampener mechanism, including a first surface, to the cap such that the first surface mates substantially flush against the combustor casing wall.

4. The method in accordance with claim 1, wherein coupling at least one dampener mechanism to the cap comprises coupling at least one dampener mechanism to an arcuate cap.

5. The method in accordance with claim 1, wherein said method further comprises compressing the dampener mechanism prior to positioning the fuel nozzle within the combustor assembly.

6. The method in accordance with claim 1, wherein coupling a cap comprises mounting a plurality of caps along a length of the fuel nozzle.

7. A fuel nozzle assembly for use with a combustor, said assembly comprising:
a fuel nozzle comprising a discharge end;
a cap coupled adjacent to said nozzle discharge end, said cap comprising an outer surface; and
at least one dampener mechanism coupled to said cap outer surface to facilitate reducing vibrations induced to said fuel nozzle.

8. The fuel nozzle assembly in accordance with claim 7, wherein said dampener mechanism comprises a biasing mechanism.

9. The fuel nozzle assembly in accordance with claim 8, wherein said biasing mechanism comprises a spring.

10. The fuel nozzle assembly in accordance with claim 7, wherein said dampener mechanism comprises:
a housing sized to receive a biasing mechanism at least partially therein; and,
an end cap slidably coupled to said housing, said end cap configured to extend between the combustor and said cap outer surface.

11. The fuel nozzle assembly in accordance with claim 10, wherein said biasing mechanism facilitates biasing said end cap between the combustor and said cap outer surface.

12. The fuel nozzle assembly in accordance with claim 10, wherein said end cap comprises an aerodynamic cross-sectional shape that comprises one of an elliptical shape, a cylindrical shape, a tear drop shape, and an airfoil shape.

13. The fuel nozzle assembly in accordance with claim 10, wherein said end cap is interlocked with said housing.

14. The fuel nozzle assembly in accordance with claim 7, wherein said dampener mechanism comprises a wear coating applied over at least a portion of a first surface of said end cap.

15. The fuel nozzle assembly in accordance with claim 7, wherein said cap outer surface is arcuate.

16. A gas turbine assembly comprising:
a combustor;
a fuel nozzle extending into said combustor, said fuel nozzle comprising a discharge end; and
at least one dampener mechanism coupled to said fuel nozzle adjacent to said discharge end such that said at least one dampener mechanism facilitates reducing vibrations induced to said fuel nozzle.

17. The gas turbine assembly in accordance with claim 16, wherein said dampener mechanism facilitates reducing vibrations induced to said fuel nozzle from at least one of fluid flowing through said fuel nozzle and from said combustor during operation.

18. The gas turbine assembly in accordance with claim 16, wherein said dampener comprises a biasing mechanism.

19. The gas turbine assembly in accordance with claim 16, wherein said dampener comprises an aerodynamic cross-sectional shape that comprises one of an elliptical shape, a cylindrical shape, a tear drop shape, and an airfoil shape.

20. The gas turbine assembly in accordance with claim 16, wherein said at least one dampener mechanism comprises a plurality of dampener mechanisms spaced circumferentially about said fuel nozzle.
